(19) United States
(12) Patent Application Publication
(10) Pub. No.: US 2016/0066184 A1
(43) Pub. Date: Mar. 3, 2016

(54) Pairing Computing Devices According To A Multi-Level Security Protocol

(71) Applicant: Intel Corporation, Santa Clara, CA (US)

(72) Inventors: Abhilasha Bhargav-Spantzel, Santa Clara, CA (US); Ned M. Smith, Beaverton, OR (US); Hormuzd M. Khosravi, Portland, OR (US); Michael Raziel, Jeruslaem (IL); Alex Nayshtut, Gan Yavne (IL)

(21) Appl. No.: 14/472,645

(22) Filed: Aug. 29, 2014

(51) Int. Cl. H04W 12/08; H04W 12/06; G06F 21/35; H04W 12/02; G06F 21/40; G06F 21/34

(52) U.S. Cl. CPC H04W 12/08; G06F 21/40; G06F 21/34; G06F 21/35; H04W 12/02; H04W 12/06

(57) ABSTRACT

In an embodiment, an apparatus includes a security engine to operate in a trusted execution environment to perform security operations and to authenticate a user of the apparatus, and a pairing logic to receive an indication of discovery of a peer device and to determine whether the user of the apparatus corresponds to a user of the peer device, and if so to enable a pairing with the peer device according to a first security ring if the correspondence is determined, and to enable the pairing with the peer device according to a second security ring if no correspondence is detected and the user of the apparatus is authenticated. Other embodiments are described and claimed.

### TECHNICAL FIELD

Embodiments relate to secure connections between multiple computing devices.

### BACKGROUND

In today's computing environment, many users own multiple computing devices. While some of these devices can communicate with each other via a pairing technique, secure pairing of devices requires user interaction with each device. This manual pairing of devices can be cumbersome for the user and undesirably impacts user experience. Furthermore, coupling of multiple devices in a trusted environment is prone to error and security vulnerabilities.

### BRIEF DESCRIPTION OF THE DRAWINGS

FIG. 1 is an illustration of pairing multiple devices in a user-centric multi-level security ring protocol in accordance with an embodiment of the present invention.

FIG. 2 is a flow diagram of a high level method for user-centric device pairing in accordance with an embodiment.

FIG. 3 is a flow diagram of a method in accordance with another embodiment of the present invention.

FIG. 4 is an illustration of an automated pairing device identification according to an embodiment.

FIG. 5 is an example of an automated trust negotiation (ATN) process in accordance with an embodiment.

FIG. 6 is an illustration of a shared key creation protocol in accordance with an embodiment.

FIG. 7 is an illustration of device pairings according to a user-centric multi-level ring protocol in accordance with an embodiment.

FIG. 8 is a block diagram of a portion of a system in accordance with an embodiment of the present invention.

FIG. 9 is a block diagram of a system arrangement in accordance with an embodiment of the present invention.

FIG. 10 is a block diagram of another example system with which embodiments can be used.

FIG. 11 is a block diagram of a system in accordance with another embodiment of the present invention.

### DETAILED DESCRIPTION

In various embodiments, multiple computing devices associated with a user may be automatically and seamlessly paired, often in a manner transparent to the user. In addition, the pairing of devices may be performed to enable devices to couple and interact with each other at an appropriate security privilege level, depending on authentication parameters and policy (e.g., involving user and/or device authentication).

More specifically, embodiments provide a technique for a multi-level user-centric pairing of computing devices associated with one or more users. The multi-level aspect of this technique provides for multiple levels of security such that based on various authentication parameters and policy, two devices may couple to each other at a particular security level or ring to enable the devices to communicate and share information according to the given security level. Furthermore, the user-centered aspect of this technique bases the privilege level of pairing of the devices at least in part on an authentication of the user of the devices.

To this end, embodiments may use device type and a relationship that a user has with a device to transparently and securely pair the device with one or more other devices at an appropriate level of trust. Multi-level trust allows two platforms to pair with each other based on the level of sharing and interaction required between the devices. To effect the pairing and connectivity between devices, in various embodiments a wide range of device capabilities may be leveraged. For example, in some embodiments available wireless protocols such as a wireless local area network communication protocol, e.g., in accordance with an Institute for Electrical and Electronics Engineers 802.11 standard (e.g. a so-called Wi-Fi™ protocol) may be used. Still further, other wireless protocols such as a Bluetooth™ protocol or a near field communication (NFC) protocol similarly may be used.

Embodiments provide a set of pairing protocols that allow transport-independent discovery of different users and resources based on a multi-level security technique. Embodiments may be applied to a variety of use cases to enable devices to be autonomously paired at an appropriate security level. In one example, a user may have different personas on different devices. Consider a user Alice who is at work and wants to pair her work phone to her work laptop computer. She has an identity established on both devices that indicates a permission to access corporate data of her employer separately (e.g., as accessed via an enterprise network, either to a dedicated enterprise system or remotely to a cloud-based service provider). However, without an embodiment of the present invention, these devices cannot transparently determine whether they have the same master user so they can be securely paired. Additionally if the context of the master user is not recognized as identical between the devices, e.g., Alice as an office worker versus Alice at home, a different type of pairing between devices may occur.

Some embodiments may use a discovery service, where discoverable attributes of a device may be placed in a registry on a second device acting on behalf of the first device. Use of such discovery service allows the first device to enter low power/sleep modes while still allowing a third device to discover its existence. In various embodiments, the discovery service may support multi-level discovery by hiding inner security level resources from outer level discovery queries. In this way, only when the discovering device authenticates itself with sufficient privilege level to the discovery service may it learn of additional capabilities of the first device. In this case, a protocol for waking the first device such as a Wake-On-LAN technique may be used by the discovery service or the third device to initiate interaction with the sleeping first device. However, care is taken to ensure that a wake-on-high-security-capability is not mandated for use, given a desire to interact with a high sensitivity level resource if knowledge of that resource by a lower level entity constitutes a security violation.

As another usage example, consider delegate offline pairing. As an example of this pairing, a senior executive Beth has several computing devices that are refreshed occasionally (by enterprise information technology (IT) personnel) so she can try out the latest technologies. However, without an embodiment of the present invention, the downside is that she does not have the flexibility to delegate pairing multiple ones of her devices to another, e.g., to her assistant. Embodiments may provide more convenience and flexibility for such pairing.

A still further example distinguishes and controls pairing accessibility between public accessibility and private connections. In publicly accessible areas, there may be fixed resources such as a conference room projector that a variety of users may access. For example, a projector may accept requests from a wide variety of display drivers. Other examples of shared fixed resources include 3D printers, traditional printers, kiosks, digital signs, point-of-sale terminals, smart transportation (cars, Segways™, bikes, etc. . . . ), among others. Using an embodiment of the present invention, a ring security model for pairing is provided where outer rings (more public) allow broader pairing permissiveness but with less access to deep information and control, while inner rings (more private) allow narrower permissiveness but with deeper access and control.

Yet another example is in the context of pairing with integrated sensors and devices. Systems are increasingly becoming complex with various types of sensors and subsystems. Consider integrated devices such as a fingerprint reader (with on-chip matching capability) as an example. Based on the trustworthiness of the device as assessed by device attestation, device pairing can be done at different levels within the platform itself. If the fingerprint reader has a trusted execution environment (TEE) that protects user information, then the pairing can be at a higher level than a similar fingerprint reader without the TEE-based on-chip matching. For example assume a first device contains a TEE hardening technology that attests to the existence of such technology as part of a pairing protocol to a second device, Platform P. If Platform P also contains a TEE capability, Device A is allowed to pair and the pairing context contains a pairing level tag (PLT) value of “High,” by policy. Instead when Device B does not contain a TEE hardening technology, it does not attest to existence of a TEE when pairing to Platform P, and the pairing protocol responds by allowing Device B to pair and assign a PLT value of “Low.” In practical implementations additional levels between High and Low may exist, e.g., “Medium,” so that security relevant design/implementation differences for a class of devices may be comprehended as part of a multi-layered/multi-level security policy and risk managed heterogeneous system of devices, peripherals and platforms.

Embodiments provide a multiple security ring protocol to support discovery and pairing within an appropriate ring (and thereafter connection and communication per the selected ring). Although the scope of the present invention is not limited in this regard, in the implementation described herein for discussion purposes, a tri-ring model is presented in which devices may pair and connect via one of 3 different rings. However, understand that in other implementations more or fewer rings may be provided. To enable selection of an appropriate range of the multi-security ring protocol to be used to pair and connect devices, embodiments may use both device and user credentials. Depending on available information and the degree of trust afforded by a particular device and user credentials, pairing and connection between devices may be controlled to be at a given one of the multiple security rings. Using an embodiment of the present invention, a pairing protocol thus provides multiple security rings to enable pairing and connection between devices with the appropriate security, convenience and transparency.

Note that selection of an appropriate security ring level at which to pair devices may be based on a variety of factors, including user, device, and context information. In this way, pairing and connection between devices may be at different levels depending on any of this information. That is, pairing and connection between devices can vary and depend on a particular user persona that has been authenticated, a location at which one or more devices are located, and a particular environment in which one or more of the devices are operating. In contrast, available typical pairing protocols simply provide a single level of pairing and connection, regardless of any of the above criteria. Accordingly, embodiments provide programmable and controllable degrees of pairing with varying levels of permissiveness based on a given policy and the available user, device and context information and resulting authentications/attestations.

While the scope of the present invention is not limited in this regard, to enable sharing and connection, each of the devices may include a mechanism for performing user and device authentication. Still further, the devices may include a mechanism to perform a discovery protocol for peer devices, e.g., present in a wireless local area network with the device or remotely available (e.g. a local area network or wide area network, an Ethernet network, an Internet-based connection or so forth). In one particular embodiment, an Intel® Common Connectivity framework (CCF) may be used to perform discovery between devices. Using this CCF framework, devices can be discovered using conventional mechanisms (e.g., a Bluetooth™ or Wi-Fi™ protocol) followed by device and user authentication challenges.

After this initial discovery, embodiments provide a further layer of discovery over an established channel between the devices. This further discovery layer may include an automated negotiation of user identity information to pair devices at a selected one of the multiple privilege levels. More specifically, based on a policy associated with the pairing devices, and user, device, and context information, pairing and connectivity between the devices can be established at a given privilege level.

Embodiments provide a flexible and secure user-centric authentication and attestation. Stated another way, embodiments provide the ability to pair devices transparently (if possible) and securely using a TEE (e.g., an Intel® Software Guard Extensions (SGX)) and appropriate authentication mechanisms, such as Intel® Multi-Factor Authentication technologies. In addition, the device pairing described herein is user-centric, in that the devices determine whether they are currently under control of a common administrator/user (meaning that the same user and same user persona is authenticated to both devices). This is especially the case for biometric identifiers that may be used in user authentication to the various devices. As such, embodiments provide for user identity and control and TEE-based policy enforcement. Embodiments further provide a ring model for multi-level degrees of pairing. That is, once device ownership (based on user identity) and device trustworthiness (based on bi-directional attestation) have been performed, the level of connectivity between the devices may be determined and enforced by the TEE.

Note that in negotiation protocols according to various embodiments, a pairing device can verify the requestor is an administrator for a peer device without knowing specifically which person is the administrator. A discovery protocol advertising the existence of a device does not disclose attributes about available resources or sub-groups until pairing is established and membership in the controlling sub-group/ring is established.

After discovery, the subsequent exchange of information may be protected over a channel specific to the level of access negotiated through pairing. In an embodiment, a secure channel endpoint can be protected using a trusted computing base (TCB) of the device according to a trusted execution environment of the target device. Note that this negotiation and pairing process may enable a better user experience, as in certain embodiments (at least for certain rings) transparent device pairing is based on passive user authentication and identity matching on each of the paired devices, which may be equivalent to a single sign on mechanism.

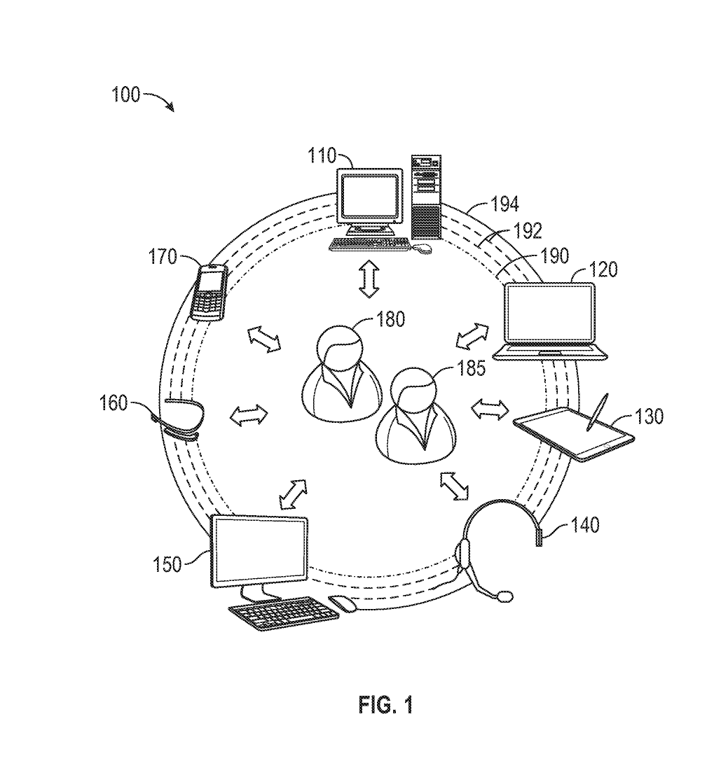

Referring to FIG. 1, shown is an illustration of pairing multiple devices in a user-centric multi-level security ring protocol in accordance with an embodiment of the present invention. As shown in FIG. 1, in an environment 100, which may be one or more locations, a plurality of devices 110-170 are present. As an example, environment 100 may be a work location such as a corporate facility that includes a variety of different computing devices that can be associated with users. In another case, environment 100 may represent multiple locations that a user may visit in the course of a day, including a home location, work location, and other location such as a public coffee shop or other public location that provides wireless access to people.

In the illustration of FIG. 1, disparate computing devices are present. Each of these devices may be a given type of computing device associated with one or more personas of one or more users. For purposes of example, assume that a single user has multiple user personas 180 and 185, with which one or more of the devices may be associated.

For purposes of illustration and not for limitation, the example devices shown in FIG. 1 include a first desktop computer system 110, which may be a user's own personal home-based personal computer, a laptop computer 120, which may be a work device assigned to the user, and a tablet computing device 130, which again may be a work device assigned to the user. Still further, FIG. 1 illustrates a wireless headset device 140, with which the user may seek to pair to one or more of the other computing devices. Understand further that in the context herein, headphone device 140 is a computing device, and may include various hardware, software and/or firmware to perform the user-centric multi-level security ring pairing described herein.

Still with reference to FIG. 1, another computing device 150 may be a user's work computer which may be coupled to an enterprise system, e.g., a corporate data center (not shown for ease of illustration in FIG. 1). Also present within the environment 100 is another portable computing device 160 such as an accessory device to access one or more of the other computing devices. Finally, a smartphone or other mobile device 170 is present, which may be a user's personal cell phone or a work-provided cell phone.

Understand that while shown with these example computing devices in the embodiment of FIG. 1, many other and different types of computing devices may take advantage of embodiments of the present invention. Furthermore, understand that to perform the pairing described herein according to one of multiple security rings, a given computing device may include certain hardware and software. At a minimum, the computing device may be configured to execute in a trusted execution environment using various hardware to perform user and device attestation and to perform discovery, negotiation, pairing and communication with paired devices as described herein.

FIG. 1 further illustrates the security ring concepts described herein in which given devices may couple via one of multiple security rings to provide for multi-level degrees of pairing between devices. In the embodiment of FIG. 1, a plurality of rings are present, including a first ring 190, which may be a private ring that affords a high level of security between paired devices and, as such based on a particular policy may enable sharing of a significant amount of the application and data information. A less privileged ring 192 is present, which may be formed of one or more different group rings that provide a group membership-based pairing between devices. In general, the level of security provided by a group ring is less than that of private ring 190. Still further, a third ring 194 may be implemented as a public ring, in which devices may be paired with relatively low levels of security such that although an attestation is performed, a user may remain anonymous. Understand that while shown with these limited security rings or levels, the scope the present invention is not limited to the illustrated and described rings and a greater number of security rings may be provided.

Via a public ring, an anonymous attestation may be performed to pair devices. In this way, the devices attest to a given level of trustworthiness, but there is no need for user trust assertions. As an example, secure discovery between devices to be paired via a public ring may be performed over a protected channel such as an Intel®-based enhanced privacy ID (EPID) protected channel. For example, a device attestation protocol may be performed to verify the state of the pairing devices, including an execution environment, type of available hardware, type of firmware available and so forth. In this way, even in the context of a public ring security level, pairing between devices is protected. However, according to this ring and a given policy, understand that the devices do not have unfettered access to each other. As differentiated from Bluetooth™ discovery and pairing which is unprotected, a pairing via a public ring according to an embodiment is protected but anonymous. Stated another way, even where devices are paired in the public ring, the devices are attested to trustworthiness of the device and user. Note in some embodiments, with even greater numbers of possible security rings, it can be a policy decision to determine whether pairing devices require attestation or not. For example, a fourth outer ring may allow any device to pair. However, due to the security risk of potentially malicious devices, the host may partition host resources into a sandbox environment that exposes only a subset of resources, which may have limited capabilities for such pairing.

Via a group ring (of which there may be one or more group rings based on additional context of the devices), a group membership-based pairing of devices may be implemented. This context can be based on identity record (e.g., group membership attributes) and/or platform sensor information. Although the scope the present invention is not limited in this regard, in representative embodiments groups may be of various types including family groups, neighborhood groups, work groups, social groups and so forth. Privacy information about the group is preserved and this pairing can leverage group-specific keys established during provisioning or group establishment. For a group ring protocol, a pairing device can verify that a requestor is a member in a public group without disclosing additional information of the user/requestor that could be aggregated by backend processes. Similarly, the pairing device can verify the requestor is a member of a sub-group without disclosing additional information that might be used for tracking.

Via a private ring, a single user as owner of multiple devices (and having presence verified) can securely pair the devices, leveraging user presence and strong authentication (e.g., a multi-factor authentication). Although different private ring protocols can be used, in an embodiment a beacon may be communicated (via a common Bluetooth™ connection or via a hub) with an Intel Protected Transaction Display™ technology that implements a trusted user input channel using a protected audio/video path (PAVP) technology to input a nonce or other security information, etc., to allow the pairing of the devices in a private ring, as an authenticated user presence is assured. In this way, the information can be displayed in a scrambled manner so that an observer in the operating system may not deduce the actual values selected (e.g., by a mouse or pointing device) even though the screen coordinates where the selection event took place is known to the attacker. Depending on the methodology used, the pairing can be passive and transparent to the user or may be active with active user participation. Note that in different implementations a broad spectrum of techniques may be used to perform the pairing.

Note that in any of the security rings described above, discovery and pairing protocols may preserve user privacy. That is, minimal disclosure regarding the user and device attributes occurs (where this disclosure may vary depending on level of ring). For example, membership in a group does not reveal personally identifiable information of the user to the pairing device or user as a condition of proving group membership. Paired devices share data selectively based on the level of trust. Embodiments thus provide enhanced system security using combinations of hardware, firmware and/or software, so malicious software on any device or a network-based attack can be prevented from impersonating as a legitimate device.

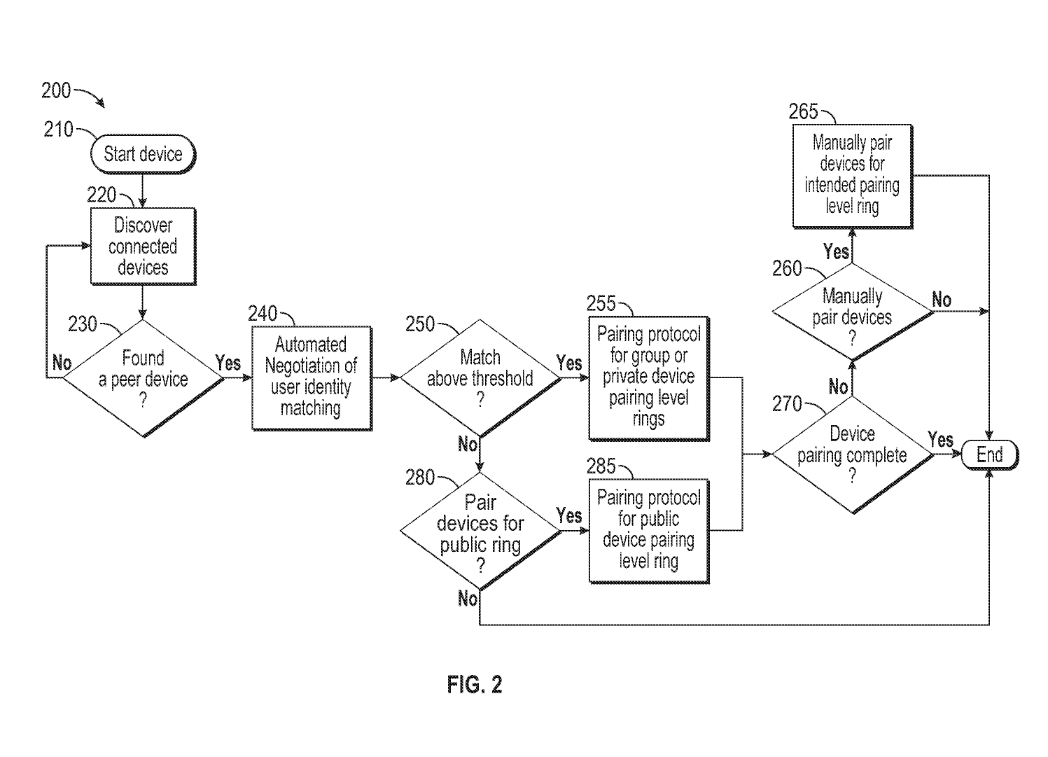

Referring now to FIG. 2, shown is a flow diagram of a high level method for user-centric device pairing in accordance with an embodiment. In general, method 200 may be performed using various hardware, software, and/or firmware of the devices to be paired, and may generally proceed through three high level steps. First, the method may automatically identify devices to be paired, e.g., based on user identity records. Next, a user-centric pairing of the devices (which may be passive or active) is performed. Thereafter, application and data sharing may occur based on a secure and privacy preserving ring model.

With particular reference now to FIG. 2, method 200 begins at block 210 when a device is started. For example, a user may power on a device and it may trigger a user authentication, e.g., as determined by various policies of the device. Or in some cases, a user may have configured a device to enable power up and initialization without any type of authentication.

Next control passes to block 220 where connected devices may be discovered. In some embodiments, this discovery process may be performed using a conventional wireless discovery process such as by way of Bluetooth™ to determine presence of wireless-enabled devices in a proximity to the device. Of course additional discovery protocols may be performed to determine presence of other devices available either within a location at which the device is present or other network locations such as achievable according to a particular wired connection. In some embodiments, the discovery may proceed responsive to a user request. At diamond 230 as a result of this discovery process, it may be determined whether a peer device is found. If so, control passes to block 240 where an automated negotiation of user identity matching may be performed. More specifically here, a selected set of user attributes of the user of the device may be communicated with the peer device (and/or vice versa) to determine whether the users are identical or at least match above a particular threshold level. Thus at diamond 250 this determination as to whether a match is above a threshold level is made. If so, control passes to block 255.

At block 255 a given pairing protocol may be performed to attempt to pair the devices. In different embodiments, e.g., according to various policy information, the pairing protocol may be for a group ring or a private ring. Next control passes to diamond 260 to determine whether the devices are to be manually paired. When an automated pairing process is performed, and it is determined at diamond 270 whether the device pairing is complete and if so, method 200 may conclude, and the paired devices may communicate according to the particular sharing protocol for the selected security ring (and any other policy information associated with the devices subject to pairing). If instead at diamond 260 it is determined that the devices are to be manually paired, e.g., according to a given policy or user request, control passes to block 265 where the devices may be manually paired at the appropriate privilege level.

Still referring to FIG. 2, if back at block 250 it is determined that the user identity matching is not above a given threshold, control passes to diamond 280 to determine whether it is desired or permitted to allow the devices to pair according to a public ring level. This determination may be based on user input, e.g., according to a prompt to the user or based on policy information. Control passes to block 285 where a pairing protocol for a public level ring is performed. Control passes to next to diamond 270 discussed above. Understand while discussed at this high level in the embodiment of FIG. 2, many variations and alternatives are possible.

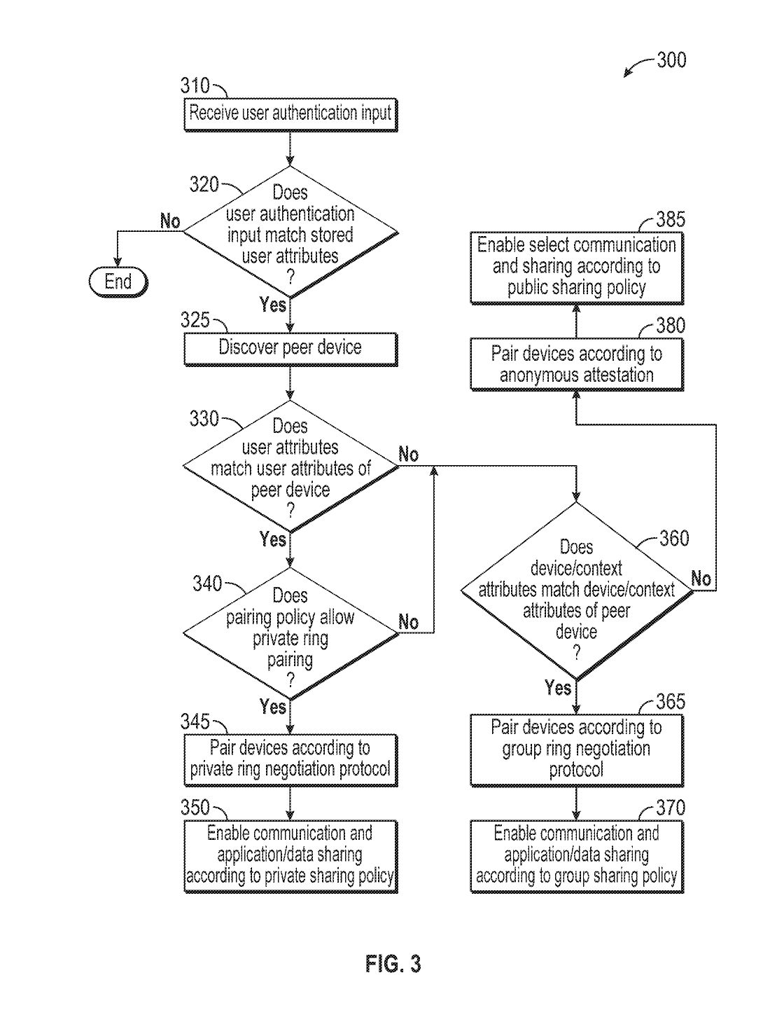

Referring now to FIG. 3, shown is a flow diagram of a method in accordance with another embodiment of the present invention. More specifically, method 300 of FIG. 3 may be performed by similar pairing logic of a device to determine based on user attributes information and policy information an appropriate level of security ring at which to allow devices to be paired, and thereafter by sharing logic to enable communications to occur according to the established security level.

As seen, method 300 begins by receiving a user authentication input (block 310). Various types of user input are possible. In the embodiment here, a multi-factor authentication may be performed, e.g., including voice information, image information, other presence information, user password, biometric information among other types of user authentication. Next, control passes to diamond 320 to determine whether the user authentication input matches stored user attributes. In a system in which policy requires at least some form of user authentication validity, if there is no match determined at diamond 320 at least to a threshold level, method 300 may conclude, and no pairing may be possible. As an example, a user identity record may store various authentication attributes, e.g., including a voice template, a fingerprint scan, an eye scan or so forth, and such information may be used to determine whether a match occurs, at least to a threshold level.

If the user is authenticated, control passes to block 325 where the device may perform a discovery protocol to determine whether one or more peer devices are present in a proximity to the device. On discovery of a peer device, control passes to diamond 330 to determine whether the user attributes of the current device match user attributes of the peer device (at least to a threshold level) (diamond 330). If so, control passes to diamond 340 to determine whether, e.g., according to the level of attribute match (such as based on the likelihood of user identity, the types of user attributes considered, or so forth) a private ring pairing is allowed. If so, control passes to block 345 where the devices may be paired according to a private ring negotiation protocol. In some implementations the private ring negotiation protocol may be an ATN, while in other embodiments some amount of user involvement may be implicated.

Thus at this point the devices are paired according to a private ring security level. Accordingly, the devices may communicate with each other in this private ring security level. Thus at block 350, communications of application/data information may be performed to share such information according to a private sharing policy. In some embodiments, a single private sharing policy may be available and shared by the devices, while in other cases the different devices may have different private sharing policies, and thus an additional negotiation (not shown for ease of illustration in FIG. 3) may be performed to determine an appropriate level of application/data sharing for the paired devices.

If instead at diamonds 330 or 340, determinations are in the negative, control passes to diamond 360 to determine whether device/context attributes indicate a match with corresponding attributes of the peer device. If so, control passes to block 365 where the devices may be paired according to a group ring negotiation protocol. In some implementations the group ring negotiation protocol may be an ATN and/or may include some amount of user involvement may be implicated.

Thus at this point the devices are paired according to a group ring security level. Accordingly, the devices may communicate with each other in this group ring security level. Thus at block 370, communications of application/data information may be performed to share such information according to a group sharing policy. This sharing may be of lesser secure information than in the case of a private ring sharing policy. In some embodiments, a single group sharing policy may be available and shared by the devices, while in other cases the different devices may have different group sharing policies, and thus an additional negotiation (not shown for ease of illustration in FIG. 3) may be performed.

Otherwise, if there is no match of these device/context attributes as determined at diamond 360, control instead passes to block 380 where the devices may be paired (optionally) according to an anonymous attestation protocol. After such pairing of the devices, communication and sharing may be enabled and may occur (block 385). Note that such sharing may be according to a given public sharing protocol, which again may be common amongst the devices or may be a result of a further negotiation. In any event, the likely scenario is that communication sharing is performed according to a public security ring is less than that of either a group or private security ring. Understand while shown with this particular illustration in FIG. 3, many variations and alternatives are possible.

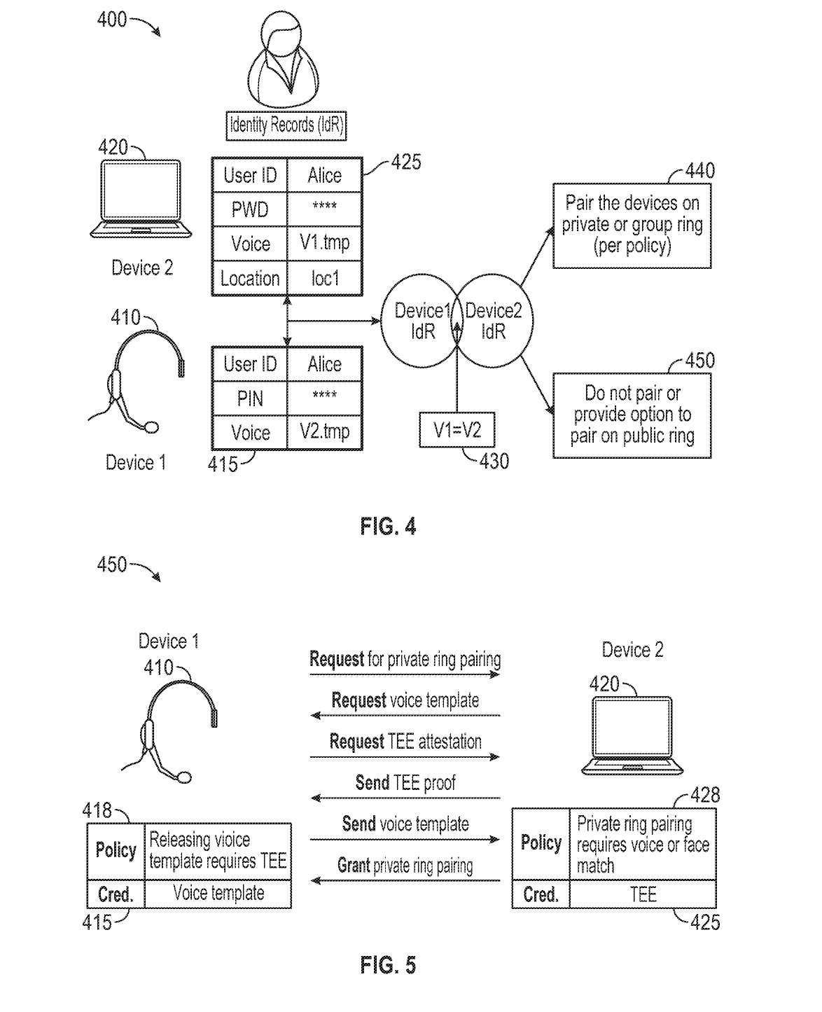

Referring now to FIG. 4, shown is an illustration of an automated pairing device identification according to an embodiment. More specifically, FIG. 4 illustrates a high level approach for pairing device identification based on negotiable identity attributes stored and managed by a TEE, such as an Intel® SGX environment. This TEE can also be used to perform user matching, and by using a TEE, the environment can be attested to for high security assurance.

As shown in FIG. 4, the negotiation may occur between peer devices 410 and 420, which as seen may correspond to a smart user headset and a portable computing device 420 such as a given laptop computer. Note that each device may include various hardware and logic to perform the negotiation and pairing described herein. To that end, each device may include a secure storage to store one or more identity records, including respective identity records 415 and 425. In various embodiments, multiple identity records may be stored within each device, each associated with a given user persona, as indicated by a user identifier. Associated with each such record are multiple fields each to store user attribute information. In the embodiment shown, user identity record 415 includes an identifier field, which is associated with a user (and more specifically a particular persona of a user), a field for personal identification number (PIN) storage, and a voice field to store a voice pattern of the user. Similarly user identity record 425 includes an identifier field, a field for password storage, a voice field to store a voice pattern of the user, and a location field to store a location at which the user is authorized to use device 420 in a pairing situation. Note for purposes of group or sub-group identification and pairing, the identity records may further store fields to identify different groups with which the user is associated.

For performing a negotiation based on identity attributes, at block 430 it can be determined whether there is a probabilistic match, e.g., based on biometric information received in the systems within a trusted execution environment (first as compared to the information in the identity records, and then a comparison between the various fields of the corresponding identity records themselves). If a match is indicated (by at least a threshold level), control passes to block 440 where the devices may be paired according to a private or group ring security level (e.g., based on the policy present in one or more of the devices). Otherwise, control passes to block 450 where the devices are not paired, or an option is provided to pair the devices via a public ring.

Referring now to FIG. 5, shown is an example of an automated trust negotiation (ATN) process in accordance with an embodiment. In a particular embodiment, a TEE may be present on both devices that participate in the ATN protocol to determine a level of match between identity records stored in the devices. As seen in FIG. 5, an ATN process 450 occurs between the same devices 410 and 420, each of which includes user attribute information in a corresponding identity record 415, 425. Further to perform the negotiation, policy information in corresponding policy storages 418 and 428 is accessed.

In the example of FIG. 5, first device 410 issues a request for a private ring pairing to second device 420. Responsive to this request and with reference to policy information stored in its policy storage 428, second device 420 issues a request for particular user attestation information, namely a voice template. Upon receipt of this request in first device 410, it issues an attestation request to device 420. More specifically, this attestation request may be (as dictated by policy information in policy storage 418) a request for attestation of the trusted execution environment of second device 420. In turn, second device 420 provides proof of its trusted execution environment, which may take the form of an Intel® SGX™ enclave or Intel® Converged Security Engine containing attestation protocols such as an Intel® Sigma protocol signed using an EPID key. The Sigma protocol establishes that the TEE is manufactured by a particular entity and is running a specific version of the TEE software. It may also establish that the TEE protects the voice template or other reference credential used to establish user authorization to pair the device. The TEE may also establish that it protects the policy used to enforce pairing behavior. The paired device may have a policy stored in policy storage 418 that accepts/rejects the attestation assertions from second device 420, in an example. On verification of this trusted execution environment proof, first device 410 sends its stored voice template to second device 420.

Thereafter, assuming that this voice template is authenticated, e.g., to a predetermined threshold level in the second device 420, a private ring pairing may be granted and communication of the grant is sent from second device 420 to first device 410 to enable the private ring pairing to be performed. Note that if there is no match, the device policies may decide to not pair or give an option to the user to pair to the public ring.

In a situation in which a passive pairing is performed (e.g., according to a given pairing policy), no user input is needed and the pairing protocol automatically pairs the devices based on the state of user authentication, user context and the connectivity ring to which the devices are to be paired. For example, for a public ring connection, user input may not be needed as the device can gather sufficient user information and context based on TEE attestation and user presence. Asymmetric keys (e.g., Rivest Shamir Adelman (RSA) key pairs) can be shared between the paired devices, and secure communication can occur using a transport layer security (TLS)-based (or similar, e.g., Intel® Sigma protocol or Diffie-Hellman key exchange) protocol (e.g., using a shared symmetric key). Other examples include an EPID implemented using ECC asymmetric cryptography/keys.

In a situation in which an active pairing is performed (e.g., according to a given pairing policy), a variety of user input may be received and used in the pairing process. In one methodology, user input based pairing is as follows:
1. Device 1 creates public and private keys <RSA_Device1_{pub}, RSA_Device1ₚᵣᵢᵥ>.
2. Device 2 creates public and private keys <RSA_Device2_{pub}, RSA_Device2ₚᵣᵢᵥ>.
3. Device 2 generates a PIN using a trusted output channel (e.g., via a trusted communication path between security processor and output device (e.g., display)) such that malware in the system cannot ascertain the PIN.
4. User reads PIN and inputs it in Device 1.
5. Device 1 then communicates its public key as follows: Device 1 sends to Device 2: [RSA_Device2_{pub},nonce]_{H(PIN)}.
6. Device 2 knows the PIN since it had generated it. Device 2 decrypts the last message and communicates its public key in the following manner: Device 2 sends to Device 1: [RSA_Device1_{pub},nonce+1].

At the end of this process, the public keys of the two devices that are being paired are set. Thereafter the devices can create shared session keys to be used to establish and maintain a secure channel for the given ring level. Note that pairing instantiated using RSA asymmetric keys is one example solution. ECC may be another and Diffie-Hellman a third (where DH produces symmetric pairing keys).

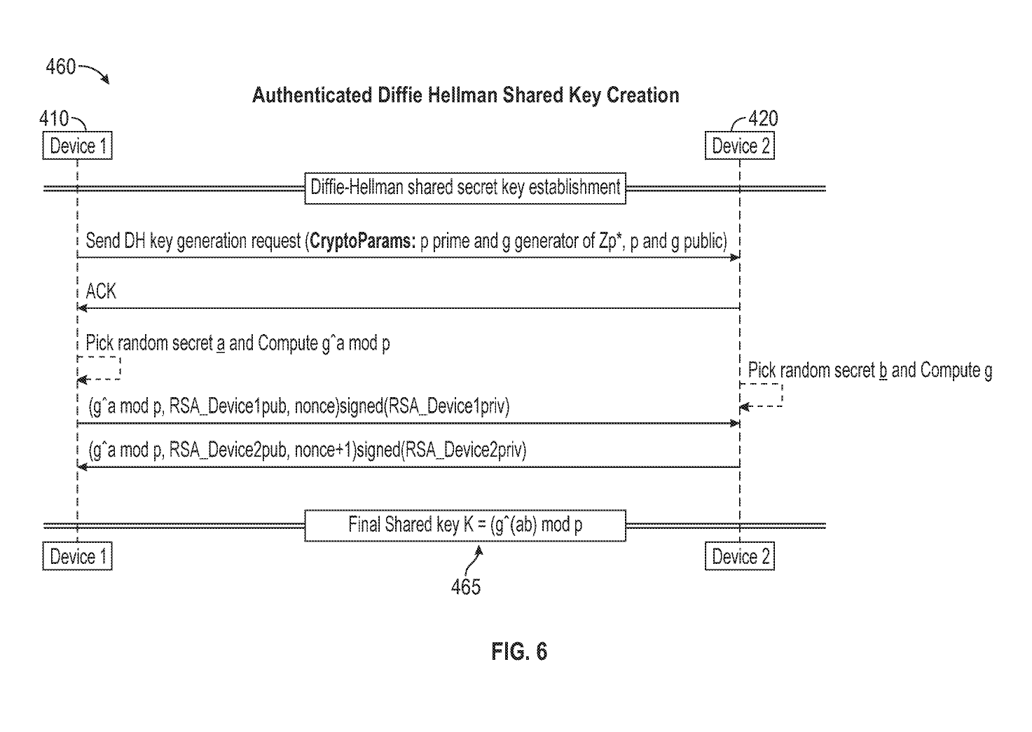

Different embodiments of shared key establishment may be used. In one example a Diffie Hellman protocol may be used to generate a shared key, such that forward secrecy is ensured and known key attacks prevented. Referring now to FIG. 6, shown is an illustration of a shared key creation protocol in accordance with an embodiment. As seen in FIG. 6, first device 410 and second device 420 perform a shared key creation process 460 in accordance with the Diffie Hellman protocol. To this end, a shared secret key is established via a negotiation in which requests, acknowledgment and communication of signed blobs are sent between the devices to result in a final shared key 465 that may be used to encrypt communications between the devices.

In another embodiment, a shared key can be updated during use for data communications. For example, a generated shared key can be updated based on incremented counters such that communication between paired devices for a given session is based on incrementing the symmetric key after each exchange according to the following:
Device 1->Device 2: E_{K+counter}(random, timestamp, RSA_Device2_{pub}).
Device 2->Device 1: E_{K+counter′}(random′, timetamp′, RSA_Device1_{pub}).

Such key update protocol prevents replay and ensures secure device-to-device communication. Note that in some embodiments key revocation and renewal may have similar options for the user based on system-based initiation of pairing state renewal.

Once the pairing is established, the devices can communicate securely with each other to perform application and data sharing based on the secure and privacy preserving ring model. Based on the ring type, policies define whether and the extent to which applications and/or data can be communicated without compromising the security and privacy policies of the applications/data.

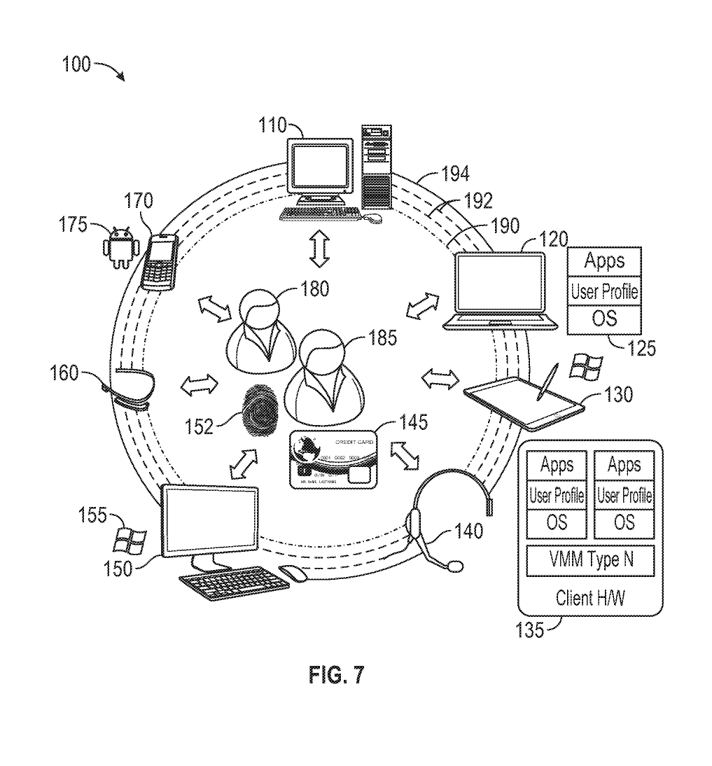

Note that this model may apply to different devices of the same user with different personas. For example in FIG. 7, a user has different personas 180 and 185 and different devices (same as in FIG. 1). Note further in FIG. 7 that according to the user-centric multi-level ring protocol, certain data and applications may be shared amongst devices while others may not be shared, at least between certain devices. Thus as shown in FIG. 7, for certain devices that pair according to a private ring protocol, virtually unfettered application/data sharing may occur (e.g., as illustrated with shared information 125 and 135 occurring between devices 120 and 130). In contrast, limited information may be shared with other devices, e.g., device 150 provides for sharing of certain shared information 155 and device 170 provides for sharing of limited shared information 175. FIG. 7 further illustrates example user attributes that may be used for authentication of one or more devices, including biometric information 152 and user financial information 145. As also seen, device 120 connected to a corporate network (e.g., by VPN) may not be allowed to pair with home desktop 110, which may not be able to comply with the software/hardware IT requirements. This determination may be made as part of attestation during a device pairing process.

Understand further that given devices may be configured to perform concurrent pairing such that a device may be paired and connected to multiple peer devices at the same time. Further, understand that in such cases, the pairing to each of the different devices may be at a security level determined for the particular pairing. Stated another way, in concurrent pairing a device may be paired to two or more different devices at different security ring levels (and thus share different types of information).

Also, using an embodiment that provides for concurrent pairing, sharing may occur between multiple devices according to a transitive property in which a device A shares information with a paired device B that in turn is further coupled to a device C. Depending on the security ring levels to which various devices are coupled, it is then possible for information from device A that is shared with device B to in turn be transitively shared with device C, depending on given security ring levels and policy.

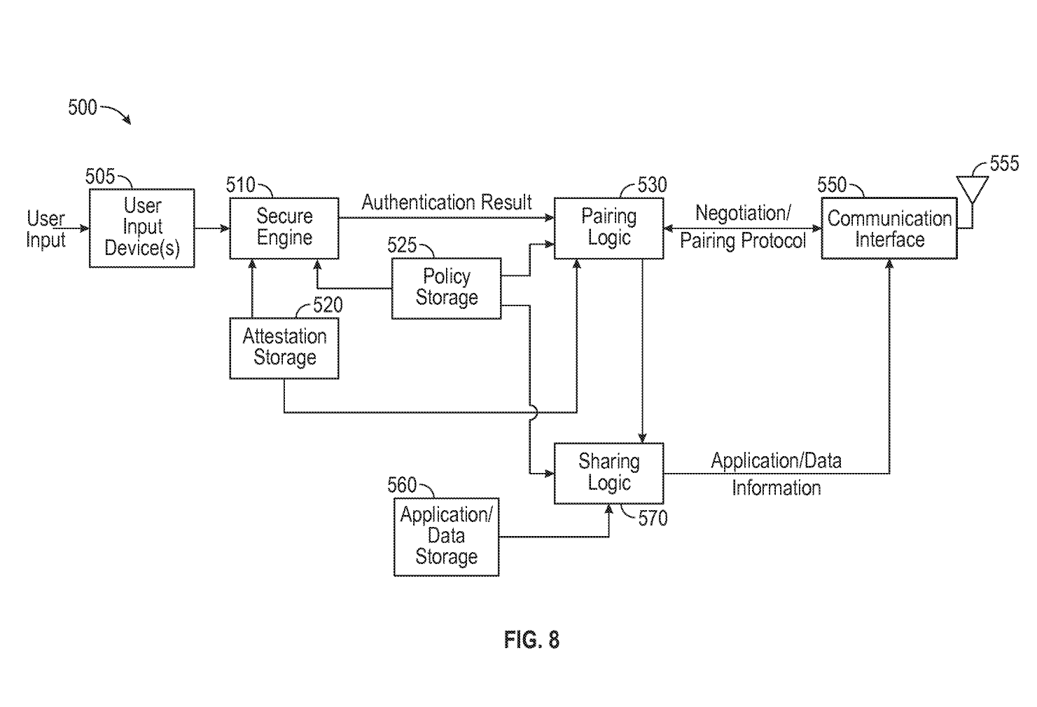

Referring now to FIG. 8, shown is a block diagram of a portion of a system in accordance with an embodiment of the present invention. As shown in FIG. 8, system 500, which may be any type of computing device, includes one or more user input device to receive user input. Types of user input devices vary in different examples and can include familiar keyboard, virtual keyboard, mouse, touchpad, touchscreen, and so forth, in addition to authentication-based devices such as a fingerprint scanner, eye scanner, among others. In turn, user input information from such user input devices are provided to a security engine 510 which in different implementations may be a standalone security processor or a secure cryptoprocessor e.g., included within a general-purpose processor such as a multicore processor or other SoC.

Based on user input information and information in an attestation storage 520 (such as a corresponding identity record to which the user input information is compared for a relative or probabilistic match), a security engine 510 may generate an authentication result, e.g., to indicate whether a given user is authenticated according to a given authentication process, as dictated by a policy stored in a policy storage 525.

Still with reference to FIG. 8, a pairing logic 530 receives a result of this authentication, and may perform a pairing protocol, e.g., with a discovered device, which may be discovered via wireless communications through a communication interface 550, which in an embodiment may be a wireless interface coupled to an antenna 555. The determination as to whether to pair two devices at a given security ring level may be based on information received from the other device and information in a pairing policy stored in policy storage 525. Assuming that the devices are permitted to pair according to a given security ring level, pairing logic 530 interfaces with sharing logic 570 which, based on a sharing policy stored in policy storage 525, may determine whether and to what extent application and/or data information stored in a storage 560 may be shared with the paired device. Understand while shown at this high level and with a limited number of components in the embodiment of FIG. 8, the scope of the present invention is not limited in this regard.

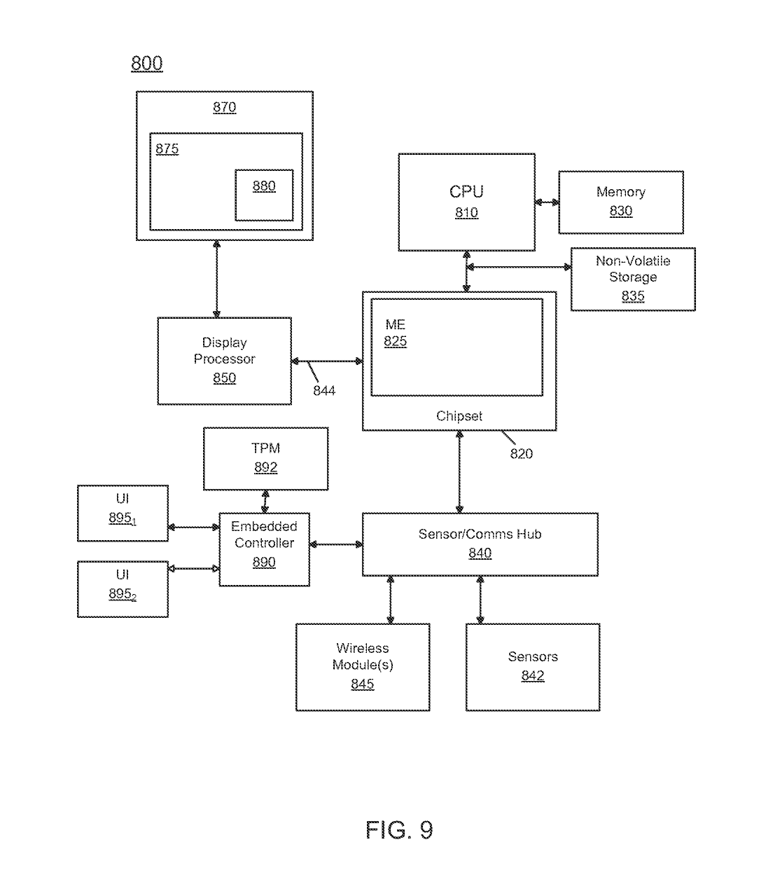

Referring now to FIG. 9, shown is a block diagram of a system arrangement in accordance with an embodiment of the present invention. As seen in FIG. 9, system 800 may be a user platform such as a personal computer, tablet, phablet (or other form factor) and includes a CPU 810. In various embodiments, this CPU may be a SoC or other multicore processor and can include secure execution technologies to set up a trusted execution environment to be used as described herein. In different embodiments, the TEE may be implemented using Intel® SGX technology, Intel® TXT technology, or an ARM TrustZone. To this end, implementations may include various hardware, both general-purpose and specialized security hardware, to create a TEE and perform secure pairing and communication operations in such environments.

As seen in the embodiment of FIG. 9, CPU 810 may be coupled to a chipset 820. Although shown as separate components in the embodiment of FIG. 9, understand that in some implementations chipset 820 may be implemented within the same package as CPU 810, particularly when the CPU is implemented as an SoC. Chipset 820 may include a manageability engine 825 which in an embodiment may be used to perform at least portions of the user-centric multi-level pairing and connection protocols described herein. As further seen, various portions of a memory system couple to CPU 810, including a system memory 830 (e.g., formed of dynamic random access memory (DRAM)) and a non-volatile storage 835, at least portions of which may be a secure storage to store user identity records, device attestation information, and/or policy information as described herein.

In the embodiment of FIG. 9, additional components may be present including a sensor/communications hub 840 which may be a standalone hub or configured within chipset 820. As seen, one or more sensors 842 may be in communication with hub 840. For purposes of user authentication and device/context attestation, such sensors can include biometric input sensors, one or more capture devices, and a global positioning system (GPS) module or other dedicated location sensor. Other sensors such as inertial and environmental sensors also may be present. As several examples, an accelerometer and a force detector may be provided and information obtained from these sensors can be used in biometric authentications. Also, in various embodiments one or more wireless communication modules 845 may be present to enable communication with local or wide area wireless networks such as a given cellular system in accordance with a 3G or 4G/LTE communication protocol.

As further seen in FIG. 9, platform 800 may further include a display processor 850 that can be coupled to chipset 820 via channel 844, which may be a trusted channel, in some embodiments. As seen, display processor 850 may couple to a display 870 that can be a touch screen display to receive user input such as responses to authentication requests. Thus in this example, configured within the display may be a touch screen 875 and a touch screen controller 880 (which of course is hidden behind the display itself). Other user interfaces, namely user interfaces 895₁ and 895₂ which in an example can be a keyboard and a mouse, may be coupled via an embedded controller 890 to sensor/communications hub 830. Also, in the embodiment of FIG. 9, a hardware TPM 892 further couples to embedded controller 890, and may be used to perform at least portions of a pairing and/or connection protocol using secrets such as various keys.

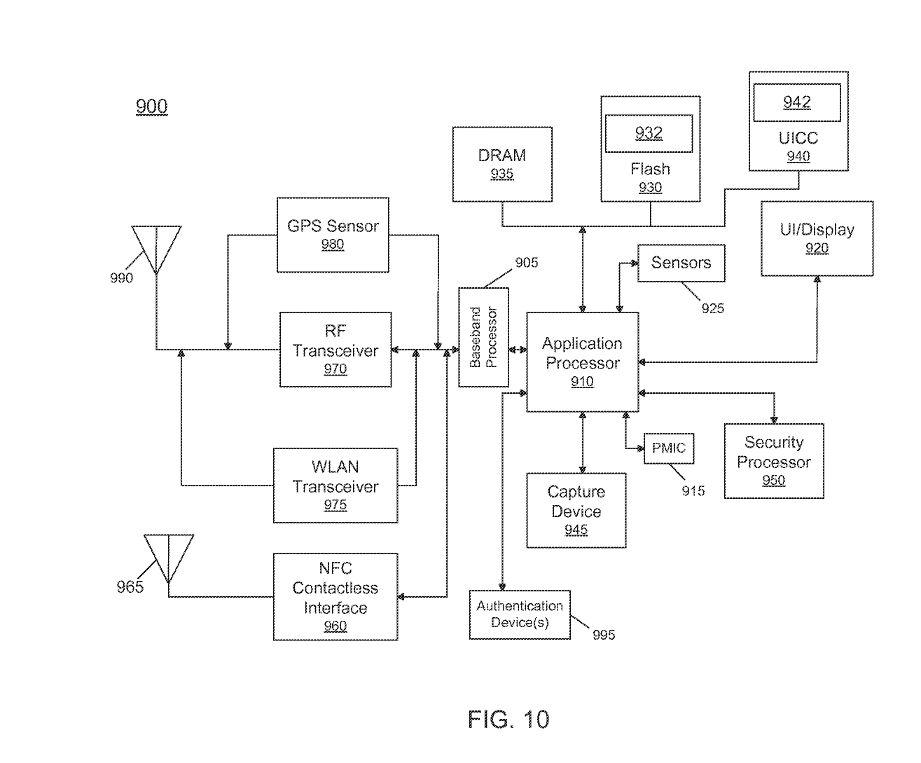

Referring now to FIG. 10, shown is a block diagram of another example system with which embodiments can be used. As seen, system 900 may be a smartphone or other wireless communicator. A baseband processor 905 is configured to perform various signal processing with regard to communication signals to be transmitted from or received by the system. In turn, baseband processor 905 is coupled to an application processor 910, which may be a main CPU of the system to execute an OS and other system software, in addition to user applications such as many well-known social media and multimedia apps. Application processor 910 may further be configured to perform a variety of other computing operations for the device.

In turn, application processor 910 can couple to a user interface/display 920, e.g., a touch screen display. In addition, application processor 910 may couple to a memory system including a non-volatile memory, namely a flash memory 930 and a system memory, namely a DRAM 935. In some embodiments, flash memory 930 may include a secure portion 932 in which user identity records, attestation information, and security policies (including pairing and sharing policies as described herein) may be stored. As further seen, application processor 910 also couples to a capture device 945 such as one or more image capture devices that can record video and/or still images.

Still referring to FIG. 10, a universal integrated circuit card (UICC) 940 comprising a subscriber identity module, which in some embodiments includes a secure storage 942 to store secure user information. System 900 may further include a security processor 950 that may couple to application processor 910. In various embodiments, at least portions of the user-centric multi-level pairing and sharing techniques may be performed using security processor 950, which may be used in part to set up a TEE. A plurality of sensors 925 may couple to application processor 910 to enable input of a variety of sensed information such as accelerometer and other environmental information. In addition, one or more authentication devices 995 may be used to receive, e.g., user biometric input for use in authentication operations.

As further illustrated, a near field communication (NFC) contactless interface 960 is provided that communicates in a NFC near field via an NFC antenna 965. While separate antennae are shown in FIG. 10, understand that in some implementations one antenna or a different set of antennae may be provided to enable various wireless functionality.

A power management integrated circuit (PMIC) 915 couples to application processor 910 to perform platform level power management. To this end, PMIC 915 may issue power management requests to application processor 910 to enter certain low power states as desired. Furthermore, based on platform constraints, PMIC 915 may also control the power level of other components of system 900.

To enable communications to be transmitted and received, various circuitry may be coupled between baseband processor 905 and an antenna 990. Specifically, a radio frequency (RF) transceiver 970 and a wireless local area network (WLAN) transceiver 975 may be present. In general, RF transceiver 970 may be used to receive and transmit wireless data and calls according to a given wireless communication protocol such as 3G or 4G wireless communication protocol such as in accordance with a code division multiple access (CDMA), global system for mobile communication (GSM), long term evolution (LTE) or other protocol. In addition a GPS sensor 980 may be present, with location information being provided to security processor 950 for use as described herein. Other wireless communications such as receipt or transmission of radio signals, e.g., AM/FM and other signals may also be provided. In addition, via WLAN transceiver 975, local wireless communications, such as according to a Bluetooth™ or IEEE 802.11 standard can also be realized.

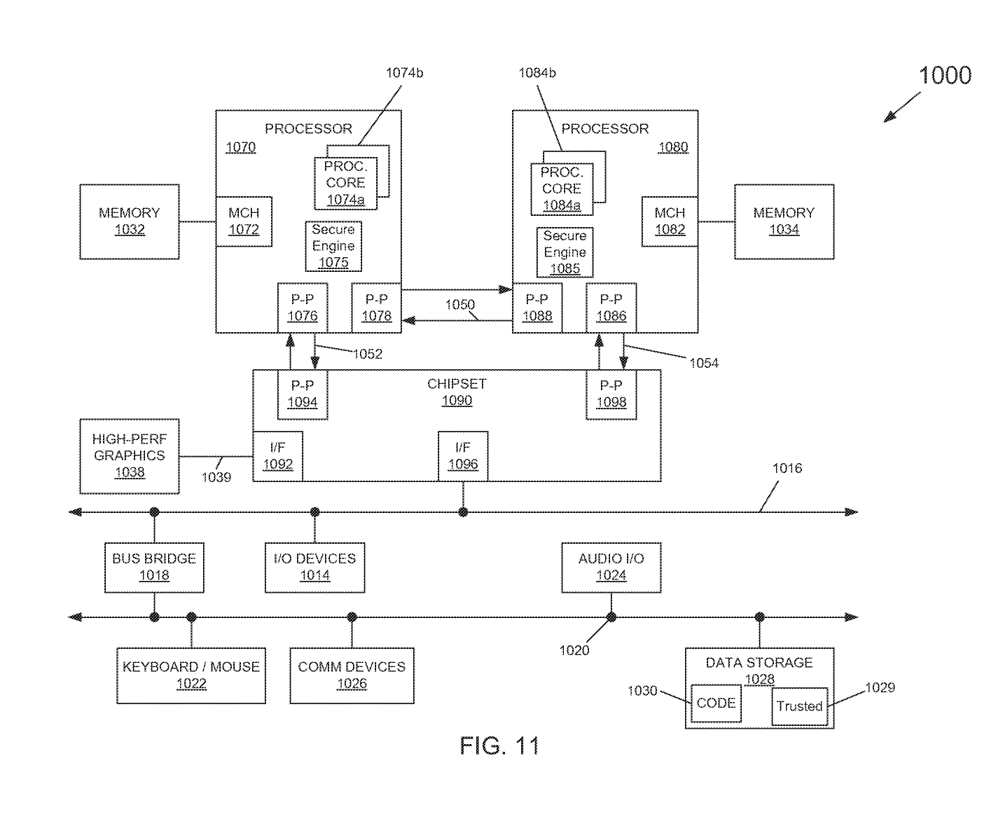

Referring now to FIG. 11, shown is a block diagram of a system in accordance with another embodiment of the present invention. As shown in FIG. 11, multiprocessor system 1000 is a point-to-point interconnect system, and includes a first processor 1070 and a second processor 1080 coupled via a point-to-point interconnect 1050. As shown in FIG. 11, each of processors 1070 and 1080 may be multicore processors such as SoCs, including first and second processor cores (i.e., processor cores 1074a and 1074b and processor cores 1084a and 1084b), although potentially many more cores may be present in the processors. In addition, processors 1070 and 1080 each may include a secure engine 1075 and 1085 to create a TEE and to perform at least portions of the trusted pairing and sharing operations described herein.

Still referring to FIG. 11, first processor 1070 further includes a memory controller hub (MCH) 1072 and point-to-point (P-P) interfaces 1076 and 1078. Similarly, second processor 1080 includes a MCH 1082 and P-P interfaces 1086 and 1088. As shown in FIG. 11, MCH's 1072 and 1082 couple the processors to respective memories, namely a memory 1032 and a memory 1034, which may be portions of main memory (e.g., a DRAM) locally attached to the respective processors. First processor 1070 and second processor 1080 may be coupled to a chipset 1090 via P-P interconnects 1052 and 1054, respectively. As shown in FIG. 11, chipset 1090 includes P-P interfaces 1094 and 1098.

Furthermore, chipset 1090 includes an interface 1092 to couple chipset 1090 with a high performance graphics engine 1038, by a P-P interconnect 1039. In turn, chipset 1090 may be coupled to a first bus 1016 via an interface 1096. As shown in FIG. 11, various input/output (I/O) devices 1014 may be coupled to first bus 1016, along with a bus bridge 1018 which couples first bus 1016 to a second bus 1020. Various devices may be coupled to second bus 1020 including, for example, a keyboard/mouse 1022, communication devices 1026 and a data storage unit 1028 such as a non-volatile storage or other mass storage device which may include code 1030, in one embodiment. As further seen, data storage unit 1028 also includes a trusted storage 1029 to store user and device attestation information and policy information, as described herein. Further, an audio I/O 1024 may be coupled to second bus 1020.

Embodiments thus provide a hardware-based solution for secure device pairing and authentication. In some embodiments, devices may be discovered using a conventional mechanism followed by device and user authentication. Still further, user experience may be enhanced as in some cases embodiments can pair devices in a transparent manner to the user (e.g., no user entry of passwords or other authentication challenges, at least with respect to the actual device pairing process).

The following examples pertain to further embodiments.

In Example 1, an apparatus comprises: a processor to execute instructions, the processor having a secure engine to operate in a trusted execution environment to perform security operations and to authenticate a user of the apparatus according to a multi-factor authentication; and a pairing logic to receive an indication of discovery of a peer device and to determine whether the user of the apparatus corresponds to a user of the peer device, and if so to enable a pairing with the peer device according to a first security ring if the correspondence is determined, and to enable the pairing with the peer device according to a second security ring if no correspondence is detected and the user of the apparatus is authenticated according to the multi-factor authentication.

In Example 2, the pairing logic is optionally to enable the pairing with the peer device according to a third security ring if no correspondence is determined and the user of the apparatus is not authenticated according to the multi-factor authentication.

In Example 3, the first security ring comprises a private ring, the second security ring comprises a group ring, and the third security ring of Example 2 comprises a public ring.

In Example 4, the public ring comprises a protected pairing, and the user of the apparatus is to be anonymous to the peer device.

In Example 5, the pairing logic of Example 3 is optionally to further enable the pairing according to the second security ring when an identity record associated with the user of the apparatus includes an identifier for a group corresponding to the group ring.

In Example 6, a sharing logic is to enable communication of trusted data when the apparatus and the peer device are paired according to the first security ring and to prevent communication of the trusted data when the apparatus and the peer device are paired according to the third security ring.

In Example 7, the pairing logic of Example 2 is optionally to communicate resource attribute information of the apparatus to the peer device only after the pairing is established.

In Example 8, the pairing logic is optionally to enable the apparatus to concurrently pair to a plurality of peer devices.

In Example 9, the concurrent pairing of Example 8 to at least one of the plurality of peer devices is according to a different one of the first, second and third security rings.

In Example 10, the apparatus of Example 1 further comprises a secure storage to store a pairing policy for the apparatus, where the pairing logic is to access the pairing policy to determine whether to enable the pairing based at least in part on a level of matching between attributes of the user of the apparatus and attributes of the user of the peer device.

In Example 11, the apparatus of Example 1 further comprises at least one user input device coupled to the processor to receive user input for the multi-factor authentication and to enable the user input to be provided to the secure engine for the multi-factor authentication.

In Example 12, at least one computer readable medium includes instructions that when executed enable a first computing device to: determine whether one or more user attributes stored in a first identity record of the first computing device at least substantially match one or more user attributes received from a second computing device, and if so to pair the first computing device and the second computing device according to a private ring protocol, based on a pairing policy; and otherwise, determine whether at least one of device attribute information and context attribute information of the first computing device at least substantially matches at least one of device attribute information and context attribute information of the second computing device, and if so to pair the first computing device and the second computing device according to a group ring protocol, based on the pairing policy.

In Example 13, the at least one computer readable medium of Example 12 further comprises instructions that when executed enable the first computing device to pair the first computing device and a third computing device according to a public ring protocol via an anonymous attestation process.

In Example 14, the at least one computer readable medium of Example 13 further comprises instructions that when executed enable communication of untrusted information between the first computing device and the third computing device according to a public sharing policy, when the first computing device and the third computing device are paired according to the public ring protocol.

In Example 15, the at least one computer readable medium of Example 12 further comprises instructions that when executed enable communication of application and data information between the first computing device and the second computing device according to a private sharing policy, when the first computing device and the second computing device are paired according to the private ring protocol.

In Example 16, the at least one computer readable medium of Example 15 further comprises instructions that when executed enable the first computing device to establish a shared key with the second computing device and to perform the communication of the application and the data information in an encrypted manner using the shared key.

In Example 17 a system comprises: a security processor to operate in a trusted execution environment to perform security operations and to authenticate a user of the system according to a multi-factor authentication; at least one user input device coupled to the security processor to receive user input for the multi-factor authentication and to enable the user input to be provided to the security processor for the multi-factor authentication; a pairing logic to receive an indication of discovery of a peer system and to determine one of a plurality of security ring levels at which the system and the peer system are to be coupled and to enable pairing of the system and the peer system according to the determined security ring level, each of the plurality of security ring levels to provide a different level of access between the system and the peer system; and a policy storage to store a pairing policy for the system, where the pairing logic is to determine the security ring level based at least in part on the pairing policy and information regarding the user authentication.

In Example 18, the system of Example 17 optionally further comprising a sharing logic coupled to the pairing logic to enable communication of trusted information between the system and the peer system when the system and the peer system are to be paired according to a private security ring level, where the trusted information communication is to be encrypted according to a shared key to be shared between the system and the peer system.

In Example 19, the pairing logic is to further determine the security ring level based on a trust negotiation between the system and the peer system, including: receipt of a request from the peer system for a requested security ring level; request of at least one credential of a user of the peer device; receipt of a request for an attestation of the trusted execution environment of the system, and responsive thereto to provide proof of the trusted execution environment; and receipt of the at least one credential of the user of the peer system, and grant of the requested security ring level if the at least one credential matches a corresponding at least one credential of a user of the system to at least a threshold level, the at least one credential of the user of the system obtained from an attestation storage of the system.

In Example 20, when the user of the system corresponds to the user of the peer system, the pairing logic is to enable the pairing of the system and the peer system according to a first security ring, to enable the pairing of the system and the peer system according to a second security ring if no correspondence is detected and the user of the system is authenticated according to the multi-factor authentication, and to enable the pairing of the system and the peer system according to a third security ring according to an anonymous attestation protocol.

In Example 21, a method for performing a secure pairing protocol comprises: determining whether one or more user attributes stored in a first identity record of the first computing device at least substantially match one or more user attributes received from a second computing device, and if so pairing the first computing device and the second computing device according to a private ring protocol, based on a pairing policy; and otherwise, determining whether at least one of device attribute information and context attribute information of the first computing device at least substantially matches at least one of device attribute information and context attribute information of the second computing device, and if so pairing the first computing device and the second computing device according to a group ring protocol, based on the pairing policy.

In Example 22, the method of Example 21 further comprises pairing the first computing device and a third computing device according to a public ring protocol via an anonymous attestation process.

In Example 23, the method of Example 22 further comprises communicating untrusted information between the first computing device and the third computing device according to a public sharing policy, when the first computing device and the third computing device are paired according to the public ring protocol.

In Example 24, the method of Example 22 further comprises communicating application and data information between the first computing device and the second computing device according to a private sharing policy, when the first computing device and the second computing device are paired according to the private ring protocol.

In Example 25, the method of Example 24 further comprises establishing a shared key with the second computing device and performing the communication of the application and the data information in an encrypted manner using the shared key.

In Example 26, at least one machine readable medium comprises a plurality of instructions that in response to being executed on a computing device, cause the computing device to carry out a method according to any one of Examples 21 to 25.

In Example 27, an apparatus for processing instructions is configured to perform the method of any one of Examples 21 to 25.

In Example 28, an apparatus comprises means for performing the method of any one of Examples 21 to 25.

In Example 29, a system for performing a secure pairing protocol comprises: means for determining whether one or more user attributes stored in a first identity record of the first computing device at least substantially match one or more user attributes received from a second computing device, and if so for pairing the first computing device and the second computing device according to a private ring protocol, based on a pairing policy; and means for determining whether at least one of device attribute information and context attribute information of the first computing device at least substantially matches at least one of device attribute information and context attribute information of the second computing device, and if so for pairing the first computing device and the second computing device according to a group ring protocol, based on the pairing policy.

In Example 30, the system of Example 29 optionally further comprising means for pairing the first computing device and a third computing device according to a public ring protocol via an anonymous attestation process.

In Example 31, the system of Example 29 optionally further comprises means for communicating untrusted information between the first computing device and the third computing device according to a public sharing policy, when the first computing device and the third computing device are paired according to the public ring protocol.

In Example 32, the system of Example 29 optionally further comprises means for communicating application and data information between the first computing device and the second computing device according to a private sharing policy, when the first computing device and the second computing device are paired according to the private ring protocol.

Understand also that various combinations of the above Examples are possible.

Embodiments may be used in many different types of systems. For example, in one embodiment a communication device can be arranged to perform the various methods and techniques described herein. Of course, the scope of the present invention is not limited to a communication device, and instead other embodiments can be directed to other types of apparatus for processing instructions, or one or more machine readable media including instructions that in response to being executed on a computing device, cause the device to carry out one or more of the methods and techniques described herein.

Embodiments may be implemented in code and may be stored on a non-transitory storage medium having stored thereon instructions which can be used to program a system to perform the instructions. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. An apparatus comprising:
a processor to execute instructions, the processor having a secure engine to operate in a trusted execution environment to perform security operations and to authenticate a user of the apparatus according to a multi-factor authentication; and
a pairing logic to receive an indication of discovery of a peer device and to determine whether the user of the apparatus corresponds to a user of the peer device, and if so to enable a pairing with the peer device according to a first security ring if the correspondence is determined, and to enable the pairing with the peer device according to a second security ring if no correspondence is detected and the user of the apparatus is authenticated according to the multi-factor authentication.

2. The apparatus of claim 1, wherein the pairing logic is to enable the pairing with the peer device according to a third security ring if no correspondence is determined and the user of the apparatus is not authenticated according to the multi-factor authentication.

3. The apparatus of claim 2, wherein the first security ring comprises a private ring, the second security ring comprises a group ring, and the third security ring comprises a public ring.

4. The apparatus of claim 3, wherein the public ring comprises a protected pairing, and wherein the user of the apparatus is to be anonymous to the peer device.

5. The apparatus of claim 3, wherein the pairing logic is to further enable the pairing according to the second security ring when an identity record associated with the user of the apparatus includes an identifier for a group corresponding to the group ring.

6. The apparatus of claim 2, further comprising a sharing logic, wherein the sharing logic is to enable communication of trusted data when the apparatus and the peer device are paired according to the first security ring and to prevent communication of the trusted data when the apparatus and the peer device are paired according to the third security ring.

7. The apparatus of claim 2, wherein the pairing logic is to communicate resource attribute information of the apparatus to the peer device only after the pairing is established.

8. The apparatus of claim 2, wherein the pairing logic is to enable the apparatus to concurrently pair to a plurality of peer devices.

9. The apparatus of claim 8, wherein the concurrent pairing to at least one of the plurality of peer devices is according to a different one of the first, second and third security rings.

10. The apparatus of claim 1, further comprising a secure storage to store a pairing policy for the apparatus, wherein the pairing logic is to access the pairing policy to determine whether to enable the pairing based at least in part on a level of matching between attributes of the user of the apparatus and attributes of the user of the peer device.

11. The apparatus of claim 1, further comprising at least one user input device coupled to the processor to receive user input for the multi-factor authentication and to enable the user input to be provided to the secure engine for the multi-factor authentication.

12. At least one computer readable medium including instructions that when executed enable a first computing device to:
determine whether one or more user attributes stored in a first identity record of the first computing device at least substantially match one or more user attributes received from a second computing device, and if so to pair the first computing device and the second computing device according to a private ring protocol, based on a pairing policy; and
otherwise, determine whether at least one of device attribute information and context attribute information of the first computing device at least substantially matches at least one of device attribute information and context attribute information of the second computing device, and if so to pair the first computing device and the second computing device according to a group ring protocol, based on the pairing policy.

13. The at least one computer readable medium of claim 12, further comprising instructions that when executed enable the first computing device to pair the first computing device and a third computing device according to a public ring protocol via an anonymous attestation process.

14. The at least one computer readable medium of claim 13, further comprising instructions that when executed enable communication of untrusted information between the first computing device and the third computing device according to a public sharing policy, when the first computing device and the third computing device are paired according to the public ring protocol.

15. The at least one computer readable medium of claim 12, further comprising instructions that when executed enable communication of application and data information between the first computing device and the second computing device according to a private sharing policy, when the first computing device and the second computing device are paired according to the private ring protocol.

16. The at least one computer readable medium of claim 15, further comprising instructions that when executed enable the first computing device to establish a shared key with the second computing device and to perform the communication of the application and the data information in an encrypted manner using the shared key.

17. A system comprising:
a security processor to operate in a trusted execution environment to perform security operations and to authenticate a user of the system according to a multi-factor authentication;
at least one user input device coupled to the security processor to receive user input for the multi-factor authentication and to enable the user input to be provided to the security processor for the multi-factor authentication;
a pairing logic to receive an indication of discovery of a peer system and to determine one of a plurality of security ring levels at which the system and the peer system are to be coupled and to enable pairing of the system and the peer system according to the determined security ring level, each of the plurality of security ring levels to provide a different level of access between the system and the peer system; and
a policy storage to store a pairing policy for the system, wherein the pairing logic is to determine the security ring level based at least in part on the pairing policy and information regarding the user authentication.

18. The system of claim 17, further comprising a sharing logic coupled to the pairing logic, wherein the sharing logic is to enable communication of trusted information between the system and the peer system when the system and the peer system are to be paired according to a private security ring level, wherein the trusted information communication is to be encrypted according to a shared key to be shared between the system and the peer system.

19. The system of claim 17, wherein the pairing logic is to further determine the security ring level based on a trust negotiation between the system and the peer system, including:
receipt of a request from the peer system for a requested security ring level;
request of at least one credential of a user of the peer device;
receipt of a request for an attestation of the trusted execution environment of the system, and responsive thereto to provide proof of the trusted execution environment; and
receipt of the at least one credential of the user of the peer system, and grant of the requested security ring level if the at least one credential matches a corresponding at least one credential of a user of the system to at least a threshold level, the at least one credential of the user of the system obtained from an attestation storage of the system.

20. The system of claim 19, wherein when the user of the system corresponds to the user of the peer system, the pairing logic is to enable the pairing of the system and the peer system according to a first security ring, to enable the pairing of the system and the peer system according to a second security ring if no correspondence is detected and the user of the system is authenticated according to the multi-factor authentication, and to enable the pairing of the system and the peer system according to a third security ring according to an anonymous attestation protocol.
